(19) United States
(12) Patent Application Publication
(10) Pub. No.: US 2010/0221387 A1
(43) Pub. Date: Sep. 2, 2010

(54) HYDROLYZED CORN GLUTEN MEAL AND METHODS FOR MAKING THE SAME

(76) Inventors: Marcelo Cristianini, Campinas-SP (BR); Luciana Carneiro Tognetti, Campinas-SP (BR); Lia Mara Marchiori Ribeiro, Mogi Guacu-SP (BR); Luciano Fachin, São Paulo-SP (BR)

Correspondence Address: FOLEY & LARDNER LLP, 150 EAST GILMAN STREET, P.O. BOX 1497, MADISON, WI, 53701-1497, US

(21) Appl. No.: 12/689,422

(22) Filed: Jan. 19, 2010

Related U.S. Application Data
(60) Provisional application No. 61/145,786, filed on Jan. 20, 2009.

(51) Int. Cl. A23J 3/34; A23L 1/305

(52) U.S. Cl. 426/63

(57) ABSTRACT

Disclosed herein are methods of making hydrolyzed proteins by enzymatic conversion. The methods provide a process for producing enzyme hydrolyzed corn gluten meal. In some embodiments, the methods utilize a multistep process using various enzyme cocktails to produce corn gluten meal with improved degree of hydrolysis and solubility.

### CROSS-REFERENCE TO RELATED APPLICATIONS

This application claims priority to U.S. Provisional Patent Application No. 61/145,786, filed Jan. 20, 2009, the entire contents of which are hereby incorporated by reference in its entirety.

### TECHNICAL FIELD

The present technology relates generally to the field of hydrolyzed food grade proteins. In one aspect, the technology relates to hydrolyzed corn gluten meal. In particular, the present technology relates to methods of producing a protein hydrolysate from corn gluten meal using a multistep enzymatic process.

### BACKGROUND

The following description is provided to assist the understanding of the reader. None of the information provided or references cited is admitted to be prior art to the present invention.

Hydrolyzed food grade proteins find several applications in the food industry and allied healthcare sectors. Proteins can be hydrolyzed into polypeptides of suitable length and free amino acids either by chemical hydrolysis or by enzymatic hydrolysis. The development of biotechnological solutions for hydrolysis of proteins is ongoing. And although a variety of enzymatic reactions are reported for popular substrates such as soy proteins and milk proteins, very few attempts have been reported in the art for hydrolysis of new substrates e.g., corn gluten meal.

Corn gluten meal (CGM) may be obtained as a byproduct during the corn wet milling process. CGM may also be obtained from dried distillers grains with solubles (DDGS), which is a byproduct of the ethanol production process. CGM is known to be one of richest concentrates of proteins having a fair level of carbohydrates and fats and is low in mineral matter. Although CGM finds widespread use as a high-protein supplement in feeds for livestock, poultry and pets, currently its use for human consumption is limited because of its low water solubility. It is, however, possible to increase water solubility of CGM by protein modification methods, such as chemical or enzymatic hydrolysis. The CGM hydrolysate so obtained can be incorporated into foods for their functional and nutritional value, as well as their flavor profile.

### SUMMARY

In one aspect, the present disclosure provides methods for producing a protein hydrolysate from corn gluten meal, the method comprising: (a) contacting a slurry of corn gluten meal with a first enzyme cocktail for at least one hour, wherein the first enzyme cocktail comprises at least one protease; (b) following step (a) contacting the slurry of corn gluten meal with a second enzyme cocktail for at least one hour, wherein the second enzyme cocktail comprises at least one aminopeptidase and at least one α-amylase; and (c) heating the slurry to inactivate the first and the second enzyme cocktail; thereby producing a protein hydrolysate.

In one embodiment, the slurry of corn gluten meal is contacted with the first enzyme cocktail for at least two hours, at least three hours, at least four hours, or at least five hours.

In one embodiment, the slurry of corn gluten meal is contacted with the second enzyme cocktail for at least two hours, at least four hours, at least six hours, or least seven hours.

In one embodiment, the methods further comprise the step of drying the protein hydrolysate to form a powder. For example, the step of drying the protein hydrolysate may be by spray drying. In one embodiment, the methods further comprise the step of isolating soluble proteins from the protein hydrolysate.

In one embodiment, the first enzyme cocktail comprises a subtilisin protease. For example, the subtilisin protease is added to the slurry at a final concentration of at least 0.04% (w/w). In one embodiment, the second enzyme cocktail comprises a subtilisin protease, an aminopeptidase, and an α-amylase. For example, the subtilisin protease is added to the slurry at a final concentration of at least 0.02% (w/w), the aminopeptidase is added to the slurry at a final concentration of at least 0.02% (w/w), and the α-amylase is added to the slurry at a final concentration at least 0.04% (w/w).

In one embodiment, the methods further comprise pre-treating the slurry with hydrogen peroxide. For example, the hydrogen peroxide may be added to the slurry at a final concentration from about 0.01% to about 0.1% (w/w). In one embodiment, the hydrogen peroxide is added to the slurry at a final concentration of about 0.04% (w/w).

In one embodiment, the methods further comprise adding disodium phosphate anhydrous to the slurry prior to contacting it with first enzyme cocktail. For example, the disodium phosphate anhydrous is added to the slurry at a final concentration from about 0.01% to 0.05% (w/w). In one embodiment, the disodium phosphate anhydrous is added to the slurry at a final concentration of about 0.03% (w/w).

In another aspect, the present invention provides a protein hydrolysate prepared by the methods described herein. The protein hydrolysate may be included in, for example, foodstuffs, animal feed, or cosmetics.

### BRIEF DESCRIPTION OF THE DRAWINGS

FIG. 1A and FIG. 1B are graphs showing the degree of hydrolysis over time for CGM.

FIG. 2A and FIG. 2B are graphs showing the percent solubility over time for CGM.

### DETAILED DESCRIPTION

In various embodiments, the present disclosure provides compositions comprising hydrolyzed proteins and methods for producing them. Although enzymatic hydrolysis has been reportedly employed in the production of hydrolysates of a variety of proteins, these methods do not provide the desired solubility or flavor to the resultant product. Quite often, this has been found to typically result in end products that have a bitter taste. Bitterness is a negative attribute associated with many food protein hydrolysates. Further, few attempts have been made to experiment with uncommon protein substrates such as CGM. Presently, applications of hydrolyzed CGM are limited because of its poor solubility in water. Due to its inherent complex matrix comprising protein, starch, and fat, and to the nature of the protein fractions, enzymatic CGM hydrolysis is amenable to a great deal of process improvement factors. Most significantly, the degree of hydrolysis, solubility, flavor profile and other functional properties of CGM can be greatly influenced by the type of enzyme or enzymes used for hydrolysis. Improved functional properties of CGM can enhance its spectrum of utility to areas such as food and beverage additives, dietary supplements, etc. The present inventors have discovered that both the solubility of proteins, such as CGM, as well as their flavor profile, can be improved by employing multiple enzyme cocktails and by optimizing the type and sequence of enzymes and other reaction conditions employed during the hydrolysis process.

The following definitions are herein provided to facilitate understanding of the invention. The terms defined below are more fully defined by reference to the specification as a whole. Units, prefixes, and symbols may be denoted in their accepted SI form.

The term “hydrolysis” as used herein refers to the chemical reaction of a molecule with water to produce two or more smaller molecules. Specific hydrolysis processes may be catalyzed by acids, alkalis, or enzymes according to type of reaction. Hydrolysis is the underlying reaction in the enzyme- or acid-catalyzed conversion of proteins to their hydrolysates. The degree of hydrolysis determines the final molecular weight and properties of the product. In one embodiment, hydrolysis of proteins is catalyzed by multiple enzyme cocktails.

As used herein, the term “degree of hydrolysis” (DH) is a parameter used to define the extent to which peptide bonds in a protein are broken by an enzymatic hydrolysis reaction. The measurement shows the number of specific peptide bonds broken during hydrolysis as a percent of the total number of specific peptide bonds present in the intact protein. The total number of peptide bonds in a protein can be calculated based on the amino acid composition therein. The number of peptide bonds cleaved can be determined by methods known in the art such as, e.g., formol titration, ninhydrin reaction, pH-stat method, osmometry and trinitrobenzenesulphonic acid assay method.

In the case of proteins, solubility is defined by “protein soluble index” or “percent solubility.” The protein is first solubilized in water under defined conditions, centrifuged and the amount of soluble protein in the supernatant and the total amount of protein are measured. The percent solubility is defined as the percentage of amount of protein in the supernatant to the total amount of protein in the sample before centrifugation.

In one aspect, a method of producing a protein hydrolysate from CGM is provided. In one embodiment, the method comprises the steps of (a) contacting a slurry of CGM at a suitable pH with a first enzyme cocktail wherein the first enzyme cocktail comprises at least one protease; (b) contacting the slurry of CGM at a suitable pH with a second enzyme cocktail, wherein the second enzyme cocktail comprises at least one aminopeptidase and at least one α-amylase; and (c) heating the slurry to inactivate the first and the second enzyme cocktail; thereby producing the protein hydrolysate.

Crude CGM obtained from various processes, e.g., as a byproduct of the wet-milling process or from DDGS, can be used for the hydrolysis method. In one embodiment, a slurry of CGM in water or any other suitable solvent is provided. In some embodiments, the slurry of CGM comprises about 5% to about 30% or from about 15% to 20% by weight of solids at the start of the reaction. The CGM slurry can be used directly or can be pre-treated prior to hydrolysis. In one embodiment, the CGM slurry is treated with hydrogen peroxide to neutralize the sulfur dioxide added during wet-milling process and/or to control the microbial growth in the CGM slurry. In some embodiments, hydrogen peroxide is added to the slurry of CGM, at a final concentration from about 0.001 to about 1% (w/w). In other embodiments, the hydrogen peroxide is added to the slurry at a final concentration from about 0.01 to about 0.1% (w/w). In an illustrative embodiment, the hydrogen peroxide is added to the slurry at a final concentration of about 0.04% (w/w).

In one embodiment, the pH of the CGM slurry is adjusted to an appropriate acidic, neutral, or alkaline pH within the functional range of the enzyme or enzymes to be used. In one embodiment, the pH of the CGM slurry is adjusted to about 4.0 to about 12.0, more preferably from about 6.0 to about 10.0, or from about 6.5 to about 8.5. In illustrative embodiments, the pH of the slurry is adjusted to a pH of about 7.0. In some embodiments, the pH of the slurry is maintained at the desired value throughout the hydrolysis reaction by adding a suitable acid and/or a base and/or a buffer. In one embodiment, the pH of the slurry is adjusted and/or maintained at the desired value using anhydrous disodium phosphate. In one embodiment, anhydrous disodium phosphate is added to the slurry at a final concentration preferably from about 0.005% to 0.1% (w/w), about 0.01% to 0.05% (w/w), or about 0.03% (w/w).

In suitable embodiments, the enzymatic hydrolysis of CGM is conducted as a multistep process. In one embodiment, the first step comprises contacting the CGM slurry with a first enzyme cocktail. In one embodiment, the first enzyme cocktail comprises at least one protease. In some embodiments, the first enzyme cocktail comprises at least one subtilisin protease. The optimal level of the enzyme added depends upon processing parameters such as raw material, processing time, pH, temperature, and the percent solids. In suitable embodiments, the subtilisin protease is added to the slurry at a final concentration of from about 0.001% (w/w) to about 1% (w/w), from about 0.01% (w/w) to about 0.1% (w/w), or about 0.04% (w/w). The step of contacting the slurry with a first enzyme cocktail is conducted for a time and at a temperature suitable to give a desired degree of hydrolysis. Accordingly, in some embodiments, the step of contacting the slurry with the first enzyme cocktail is conducted for at least about 10 min, more preferably at least about 30 min, most preferably at least about 1 hr. In an illustrative embodiment, the step of contacting the slurry with the first enzyme cocktail is conducted for about 5 hours. In one embodiment, the step of contacting the slurry with a first enzyme cocktail is conducted at a temperature of about 20° C. to about 100° C., at about 50° C. to about 70° C., or at about 60° C.

In some embodiments, the step of contacting the slurry with a first enzyme cocktail is followed by a second step comprising contacting the CGM slurry with a second enzyme cocktail. In one embodiment, the second enzyme cocktail comprises at least one aminopeptidase. In other embodiments, the second enzyme cocktail comprises at least one α-amylase. In some embodiments, the second enzyme cocktail comprises at least one aminopeptidase and at least one α-amylase. In other embodiments, the second enzyme cocktail comprises at least one protease, at least one aminopeptidase and at least one α-amylase. In an illustrative embodiment, the second enzyme cocktail comprises a subtilisin protease, an aminopeptidase, and an α-amylase. In suitable embodiments, the subtilisin protease is added to the slurry at a final concentration of from about 0.005% (w/w) to about 0.05% (w/w), more preferably from about 0.01% (w/w) to about 0.03% (w/w), most preferably about 0.02% (w/w); the aminopeptidase is added to the slurry at a final concentration of from about 0.005% (w/w) to about 0.05% (w/w), more preferably from about 0.01% (w/w) to about 0.03% (w/w), most preferably about 0.02% (w/w); and the α-amylase is added to the slurry at a final concentration of from about 0.01% (w/w) to about 0.07% (w/w), more preferably from about 0.03% (w/w) to about 0.05% (w/w), most preferably about 0.04% (w/w).

The step of contacting the slurry with a second enzyme cocktail is conducted for a time and at a temperature suitable to give a desired degree of hydrolysis. Accordingly, in some embodiments, the step of contacting the slurry with the second enzyme cocktail is conducted for at least about 10 min, at least about 30 min, or at least about 1 hr. In an illustrative embodiment, the step of contacting the slurry with the second enzyme cocktail is conducted for about 7 hours. In one embodiment, the step of contacting the slurry with a second enzyme cocktail is conducted at a temperature of about 20° C. to about 100° C., more preferably at about 50° C. to about 70° C., most preferably at about 60° C.

The following is a short description of the enzymes that may be used in the current methods:

A protease is an enzyme that conducts proteolysis by hydrolysis of the peptide bonds that link amino acids together in the polypeptide chain. Proteases are currently classified into different groups such as serine proteases, threonine proteases, cysteine proteases, aspartic acid proteases, metalloproteases, and glutamic acid proteases. Suitable proteases of the methods are proteases from microbiological origins, as for instance fungal proteases or bacteriological proteases. One suitable protease is a subtilisin protease, which is a serine endopeptidase derived from subtilisins secreted in large amounts from many Bacillus species and is well known to those skilled in the art. In one embodiment, the subtilisin protease is Alkalase® from Novozymes. This enzyme reportedly has an operating pH range of 5 to 12.

Aminopeptidases are proteolytic enzymes which catalyze the cleavage of amino acids from the amino terminus of protein or peptide substrates. Aminopeptidases are classified into different evolutionary families according to their sequence motifs and preferred substrates. Suitable aminopeptidases include Flavourzyme® from Novozyme which has an operating pH range from 3.0 to 9.0 (optimum at 7.0) and an operating activity at a temperature from 30° C. to 70° C. (optimum at 50° C.).

α-amylases are enzymes that typically catalyze the hydrolysis of starch to sugar to produce carbohydrate derivatives. Suitable α-amylases include BAN 240 L (Novozymes), which is an α-amylase from Bacillus amyloliquefaciens used in a pH range from 4.0 to 9.0 (optimum at 6.0) and temperature from 30° C. to 90° C. (optimum at 70° C.).

Other enzymes which can be used as a part of the enzyme cocktail may include lipases, papain, or blends, such a PAL blend, cellulase, hemi-cellulase, glucoamylase, β-amylase, pancreatin, etc.

In some embodiments, the reaction is carried out under conditions suitable and for a time sufficient to cause the desired degree of hydrolysis. In one embodiment, the protein hydrolysate has a degree of hydrolysis of at least about 10%. In other embodiments, the protein hydrolysate has a degree of hydrolysis of at least about 15%. In some embodiments, the protein hydrolysate has a degree of hydrolysis of at least about 30%. In illustrative embodiments, the CGM hydrolysate has a degree of hydrolysis of from about 10% to about 15%.

The hydrolysis reaction as conducted above also improves the solubility profile of the resultant protein hydrolysate. In one embodiment, the protein hydrolysate has a solubility in water of at least 15%. In some embodiments, the protein hydrolysate has a solubility in water of at least 20%. In other embodiments, the protein hydrolysate has a solubility in water of at least 30%.

The enzymatic process may be stopped at the desired stage by methods such as heating the slurry or by the addition of acid. In one embodiment, once the hydrolysate has reached the desired degree of solubility and degree of hydrolysis, the slurry is heated to inactivate the first and the second enzyme cocktail. The temperature and time of heating will depend on factors such as the type and amount of enzyme to be deactivated. Accordingly, in suitable embodiments, the slurry is heated to a temperature from about 60° C. to about 100° C., more preferably from about 75° C. to about 95° C., most preferably to about 85° C.; for a period of about 5 to about 90 min, more preferably about 10 to about 60 min, most preferably about 15 to about 45 min.

In some embodiments, the protein hydrolysate is isolated from the slurry after the enzymes are inactivated. The hydrolyzed CGM can be separated from the insoluble mass by any suitable, conventional method, such as filtration or centrifugation or combinations thereof. The isolated hydrolysate may then be further processed, if desired, to get it into a more usable form. The hydrolysate can be subjected to decolorization and deodorization processes, which are conventionally carried out by the use of activated carbon. The hydrolysate may then be concentrated by conventional methods such as spray drying, vacuum tray drying or evaporation. In one embodiment, the step of isolating the protein hydrolysate is performed by spray drying the slurry.

In one aspect, a protein hydrolysate prepared by the multi step enzymatic process as described above is provided. In some embodiments, a protein hydrolysate made from CGM by the above-described method is provided. In an illustrative embodiment, embodiment, a protein hydrolysate produced by the method comprising the steps of (a) contacting a slurry of CGM at a suitable pH with a first enzyme cocktail wherein the first enzyme cocktail comprises at least one protease; (b) contacting the slurry of CGM at a suitable pH with a second enzyme cocktail, wherein the second enzyme cocktail comprises at least one aminopeptidase and at least one α-amylase; and (c) heating the slurry to inactivate the first and the second enzyme cocktail is provided.

The protein hydrolysates prepared by the current method can find application in various industries such as foods, pharmaceuticals, nutraceuticals, cosmetics etc. The hydrolysates can be used in, e.g., non-dairy products, meat analogs, flavorings, pasta, tofu, sauces, soups, tablets, nutritional bars and beverages, infant formula, special dietary needs formula, reduced allergenicity formulas, skin-care and hair-care compositions etc. Accordingly, in one embodiment, a foodstuff comprising the protein hydrolysate is provided. In another embodiment, a cosmetic comprising the protein hydrolysate is provided. In yet another embodiment, the hydrolysate is included in animal feeds, and provided in the form of a powder, extruded pellets, or canned, etc.

In one embodiment, CGM may be prepared from DGGS, which is the dried residue remaining after the starch portion of the grain is fermented in the ethanol production process with selected yeasts and enzymes to produce ethanol and carbon dioxide. The remaining grain nutrients are protein, fiber and oil. After the complete fermentation, the alcohol is removed by distillation and the remaining fermentation residues are dried. DDGS is an excellent digestible protein and energy source for beef cattle and other animals. It is rich in cereal and residual yeast protein, minerals and vitamins.

Although, as an illustrative embodiment, the description has been exemplified for CGM, the methods can be employed to a variety of proteins. Exemplary proteins which can be hydrolyzed by the method of the present invention include animal proteins such as milk protein, whey protein, casein, meat protein, blood protein, fish, chicken, beef, egg, yeast, etc., as well as vegetable proteins, such as soy, grain, rape seed, peanut, alfalfa, pea, fabaceous bean, sesame seed, bean soy, lactoabumin, sunflower, wheat, corn, peas, sorghum, barley, cottonseed, rice, rye, oat, DGGS, etc. The methods can also be used to hydrolyze pre-hydrolyzed proteins i.e., peptides or a mixture of proteins and peptides.

### EXAMPLES

The present invention is further illustrated by the following examples, which should not be construed as limiting in any way.

### Example 1

### Hydrolysis of Corn Gluten Meal

A slurry of corn gluten meal (CGM) was made at approximately 16-17% (w/w) solids. 0.4% (w/w) of 30% H₂O₂ was added and the slurry was heated to 60° C. 0.03% (w/w) of disodium phosphate was added to the slurry. The pH was adjusted to 7 with 50% NaOH. 0.04% (w/w) of subtilisin protease (Alcalase®, Novozymes) was added to the slurry. The reaction was continued at 60° C. for 5 hr with low agitation. The pH is again adjusted to 7 with 50% NaOH. A second enzyme cocktail comprising 0.02% (w/w) of subtilisin protease (Alcalase®, Novozymes), 0.02% (w/w) of aminopeptidase (Flavourzyme®, Novozymes) and 0.04% (w/w) of an endo α-amylase (BAN 240L, Novozymes) were added to the slurry. The reaction was continued at 60° C. for 7 hr with low agitation. The enzymes were inactivated by heating at 85° C. for 30 minutes.

### Determination of the Decree of Hydrolysis (DH)

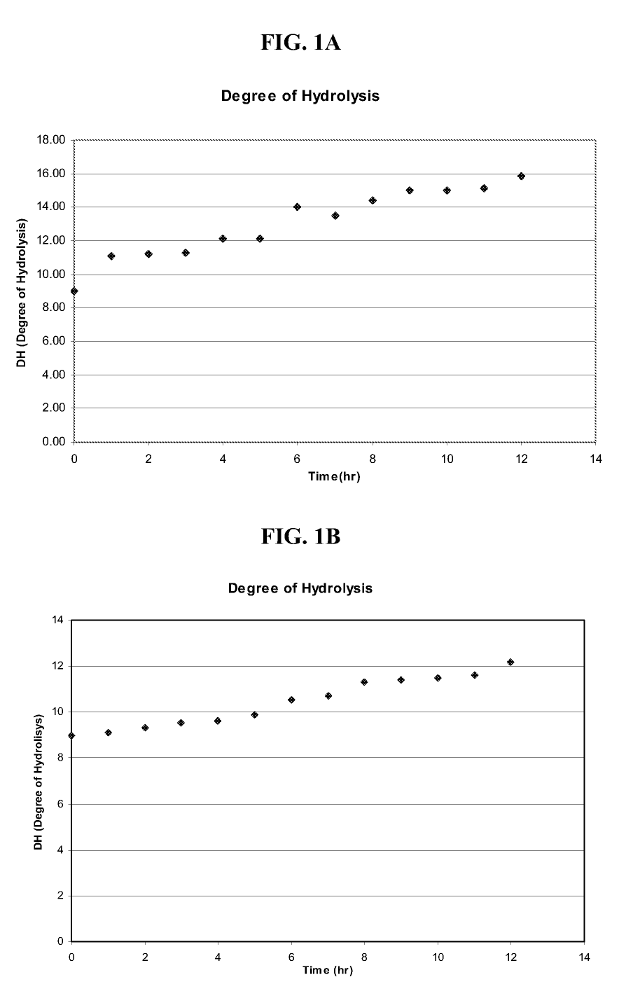

The degree of hydrolysis was determined by the method described by Dennis Petersen et al. (Novozymes A/S, ED-9512723, December 1995). The degree of hydrolysis is defined as the percentage of peptide bonds cleaved. For every peptide bond hydrolyzed a free α-amino group is formed. Free α-amino groups react with OPA (o-Phthaldialdehyde) and form a yellowish complex. The optical density was measured spectrophotometrically, at 340 nm. The results are as shown in FIG. 1. FIG. 1A shows the results of an experiment conducted as described above with a initial solids content of 16.4% (w/w). The total protein in the sample was 10.36%. FIG. 1B shows the results of an experiment where the initial solids content was 17.0% (w/w). The total protein in the sample was 12.39%. The results indicate that the degree of hydrolysis of CGM increases significantly with time.

### Determination of Solubility of Hydrolyzed Product

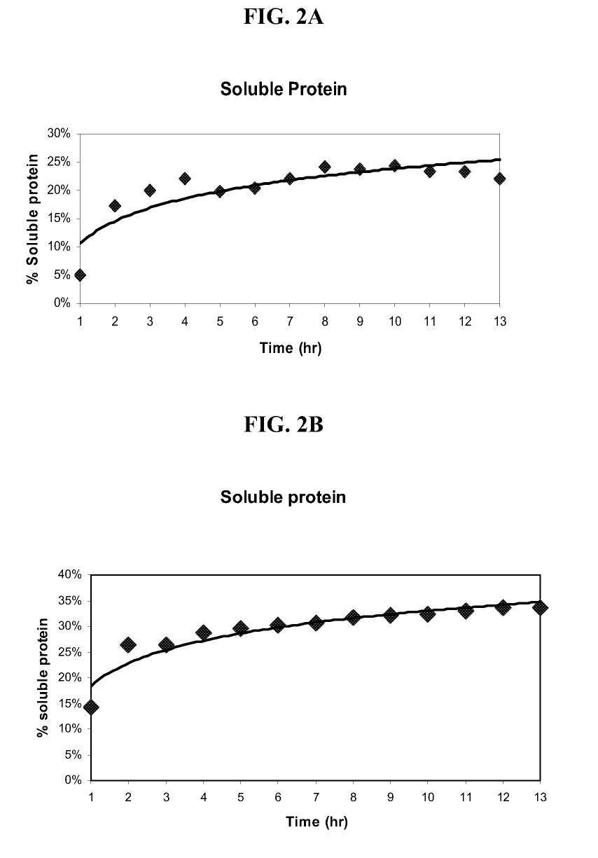

The solubility of hydrolysis product, was determined by measuring the amount of protein in the supernatant after centrifuging the hydrolysate at 3600 rpm for 30 min. The results are as shown in FIG. 2. The results indicate that the solubility of CGM hydrolysate increases significantly with time. As such, the method comprising two-step enzymatic hydrolysis of CGM are useful to provide a protein hydrolysate that advantageous solubility and flavor characteristics.

It should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

All publications, patent applications, patents, and other references mentioned herein are expressly incorporated by reference in their entirety, to the same extent as if each were incorporated by reference individually.

Other embodiments are set forth within the following claims.

What is claimed is:

1. A method of producing a protein hydrolysate from corn gluten meal, the method comprising:
(a) contacting a slurry of corn gluten meal with a first enzyme cocktail for at least one hour, wherein the first enzyme cocktail comprises at least one protease;
(b) following step (a) contacting the slurry of corn gluten meal with a second enzyme cocktail for at least one hour, wherein the second enzyme cocktail comprises at least one aminopeptidase and at least one α-amylase; and
(c) heating the slurry to inactivate the first and the second enzyme cocktail; thereby producing a protein hydrolysate.

2. The method of claim 1, wherein the slurry of corn gluten meal is contacted with the first enzyme cocktail for at least five hours.

3. The method of claim 1, wherein the slurry of corn gluten meal is contacted with the second enzyme cocktail for at least seven hours.

4. The method of claim 1 further comprising the step of drying the protein hydrolysate to form a powder.

5. The method of claim 4, wherein the step of drying the protein hydrolysate is by spray drying.

6. The method of claim 1 further comprising the step of isolating soluble proteins from the protein hydrolysate.

7. The method of claim 1, wherein the first enzyme cocktail comprises a subtilisin protease.

8. The method of claim 1, wherein the subtilisin protease is added to the slurry at a final concentration of at least 0.04% (w/w).

9. The method of claim 1, wherein the second enzyme cocktail comprises a subtilisin protease, an aminopeptidase, and an α-amylase.

10. The method of claim 1, wherein the subtilisin protease is added to the slurry at a final concentration of at least 0.02% (w/w), the aminopeptidase is added to the slurry at a final concentration of at least 0.02% (w/w), and the α-amylase is added to the slurry at a final concentration at least 0.04% (w/w).

11. The method of claim 1, wherein the pH of the slurry is adjusted to about 7.

12. The method of claim 1, wherein heating the slurry comprising heating the slurry to a temperature from about 75° C. to about 95° C. for about 15 to 45 min.

13. The method of claim 1, wherein the slurry of corn gluten meal comprises from 10% to 20% by weight solids.

14. The method of claim 1, which further comprises pre-treating the slurry with hydrogen peroxide.

15. The method of claim 14, wherein the hydrogen peroxide is added to the slurry at a final concentration from about 0.01% to about 0.1% (w/w).

16. The method of claim 1, which further comprises adding disodium phosphate anhydrous to the slurry prior to contacting it with first enzyme cocktail.

17. The method of claim 16, wherein the disodium phosphate anhydrous is added to the slurry at a final concentration from about 0.01% to 0.05% (w/w).

18. The method of claim 1, wherein the protein hydrolysate has a degree of hydrolysis from about 8% to about 20%.

19. The method of claim 1, wherein the protein hydrolysate has a solubility in water of at least 30%.

20. A protein hydrolysate prepared by the method according to claim 1.
